(19) United States
(12) Patent Application Publication
(10) Pub. No.: US 2017/0316451 A1
(43) Pub. Date: Nov. 2, 2017

(54) INFORMATION PROCESSING APPARATUS AND INFORMATION PROCESSING METHOD

(71) Applicant: YAHOO JAPAN CORPORATION, Tokyo (JP)

(72) Inventor: Ikuo KITAGISHI, Tokyo (JP)

(73) Assignee: YAHOO JAPAN CORPORATION, Tokyo (JP)

(21) Appl. No.: 15/654,224

(22) Filed: Jul. 19, 2017

Related U.S. Application Data
(63) Continuation of application No. 15/015,398, filed on Feb. 4, 2016.

(30) Foreign Application Priority Data
Mar. 19, 2015 (JP) 2015-056064
Mar. 19, 2015 (JP) 2015-056065
Mar. 19, 2015 (JP) 2015-056066
Mar. 19, 2015 (JP) 2015-056067

(51) Int. Cl. G06Q 30/02

(52) U.S. Cl. CPC G06Q 30/0244

(57) ABSTRACT

An information processing apparatus includes a determination unit that determines the degree of familiarity between a user and an artifact that performs interactive interaction with the user, on the basis of at least one of the type and the amount of the user's action detected when the artifact is accompanied by the user, and a change unit that changes the content of the interaction in accordance with the degree of familiarity determined by the determination unit.

### CROSS-REFERENCE TO RELATED APPLICATION(S)

This is a Continuation of application Ser. No. 15/015,398, filed Feb. 4, 2016, which claims priority of Japanese Patent Application No. 2015-056064, No. 2015-056065, No. 2015-056066 and No. 2015-056067 filed in Japan on Mar. 19, 2015. The disclosures of the prior applications are hereby incorporated by reference herein in their entirety.

### BACKGROUND OF THE INVENTION

### 1. Field of the Invention

The present invention relates to interaction between human beings and artifacts.

### 2. Description of the Related Art

Proposals have been made in which service robots in stores determine degrees of familiarity with users directly before the robots on the basis of the user's facial expressions or the distances therebetween in conversations and respond to the users according to the degrees of familiarity. For example, refer to Japanese Patent Application Laid-open No. 2011-000681.

When an artifact such as a robot is for individual use, it is difficult to determine the degree of familiarity from a user's transient behavior because the determination is based on a continuous relation with the user. When the behavior of the artifact toward the user is too familiar or too distant, it is difficult to make smooth interaction between the user and the artifact.

### SUMMARY OF THE INVENTION

It is an object of the present invention to at least partially solve the problems in the conventional technology.

According to one aspect of an embodiment, an information processing apparatus includes a determination unit that determines a degree of familiarity between a user and an artifact, the artifact performing interactive interaction with the user, on the basis of at least one of a type and an amount of the user's action detected when the artifact is accompanied by the user and a change unit that changes a content of the interaction in accordance with the degree of familiarity determined by the determination unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram illustrating a structure of an embodiment;

FIG. 2 is a schematic diagram illustrating an example of data in the embodiment;

FIG. 3 is a schematic diagram illustrating another example of data in the embodiment;

FIG. 4 is a schematic diagram illustrating still another example of data in the embodiment; and

FIG. 5 is a flowchart illustrating an example of processing in the embodiment.

### DETAILED DESCRIPTION OF THE PREFERRED EMBODIMENTS

The following describes embodiments with reference to the accompanying drawings. The premises in common with those described in the background are omitted.

The embodiments aim to achieve smooth interaction adapted for the degree of familiarity with a user. The embodiments further aim to select an advertisement having a value according to a relation between an artifact and the user of the artifact. The embodiments still further aim to adapt a form of the advertisement output from the artifact to the degree of familiarity with the user. The embodiments still further aim to evaluate an advertising effect including memorization in accordance with a characteristic of interactive interaction.

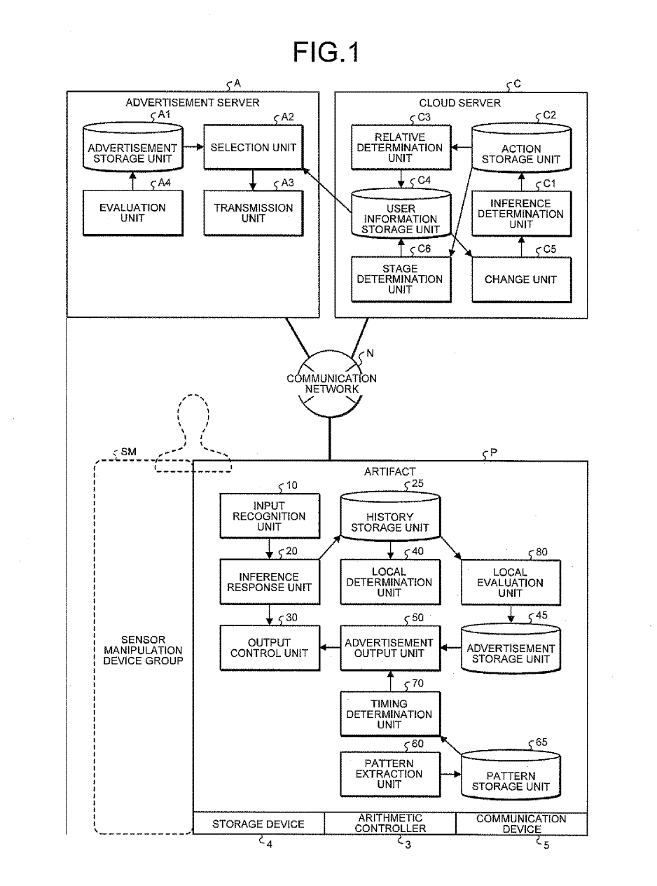

### 1. Structure FIG. 1

FIG. 1 is a schematic diagram illustrating an overall structure of an information processing apparatus according to an embodiment. The information processing apparatus in the embodiment is achieved as a system in which an artifact P, and servers A and C are coupled with a communication network N (e.g., the Internet or a cellular phone network), and the degree of familiarity between the artifact P and the user of the artifact P is determined, an advertisement is output in accordance with the degree of familiarity, and an advertising effect is evaluated.

The artifact P is an information processing device, which is typically a robot. Any type of robot is adoptable, such as a human type robot or an animal type robot. The artifact P may be a mobile information terminal such as a smartphone or a tablet personal computer (PC). The artifact P may be a software agent, which is a virtual character operating on the information processing device.

The server C, which functions as a back-end system using artificial intelligence technologies, for example, provides interaction of the artifact P with the user by network computing, what is called cloud computing.

The artifact P and the servers C and A each have a computer structure that includes an arithmetic controller 3 such as a central processing unit (CPU), a storage device 4 such as a main memory or an auxiliary storage device, and a communication device 5 (e.g., communication equipment or a communication adaptor) that communicates with the communication network N. The computer structure is illustrated in the artifact P but is not illustrated in the servers A and C.

The artifact P further includes a sensor manipulation device group SM that acquires external information and acts on the outside of the artifact P. The sensor manipulation device group SM includes a visual system (e.g., a camera, or equipment using infrared rays or laser light beams), an auditory system such as a microphone, a posture-navigation system (e.g., an accelerometer, or positioning equipment using a global positioning system (GPS)), an information output system (e.g., a speaker for utterance, a display screen, or an infrared ray output device), a driving system (wheels for moving or a mechanism achieving gestures by moving legs, arms, hands, a head, and a body, for example), and a built-in battery control system. The systems each have hardware and software. The individual systems are not illustrated.

The artifact P in the embodiment includes the computer structure (the arithmetic controller 3, the storage device 4, and the communication device 5) as the control device that controls the body (including an outer case, joints, and the driving system) and the sensor manipulation device group SM of the robot. The control device, however, may be separated from the artifact P.

It is not indispensable for the artifact in the embodiment to include a function of information processing. The artifact P may include only the body, the driving system such as actuators, and necessary sensors so as to be structured like a puppet. An externally provided control device may control the interaction, and the recognition, calculation, and movement control associated with the interaction of the artifact P by transmitting signals in a wired or wireless manner and supplying electrical and mechanical power, pneumatic pressure, or hydraulic pressure.

In each of the artifact P and the servers C and A, the arithmetic controller 3 executes a computer program stored in the storage device 4 to achieve the respective components (refer to FIG. 1) that achieve the following functions and operations.

### 2. Determination of Degree of Familiarity

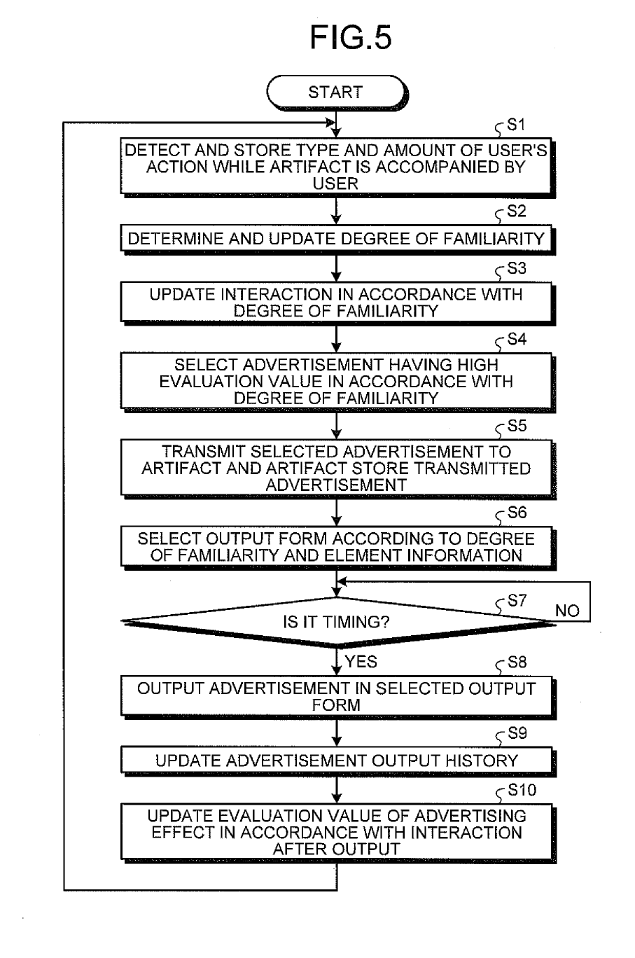

FIG. 5 is a flowchart illustrating an overview of the information processing in the embodiment. In the embodiment, a determination unit (a local determination unit 40 included in the artifact P and a relative determination unit C3 included in the cloud server C) determines the degree of familiarity between the artifact P and the user of the artifact P (step S2).

For the determination, the artifact P performs interactive interaction with the user. The interactive interaction is a mutual action mainly using conversations (utterances to the other party and recognition of the other party's utterances) and, if necessary, gestures, physical contacts with the other party, and input and output of characters, images, and sounds. In the following description, the interactive interaction is simply described as the “interaction”.

The artifact P can recognize the user and external things, perform processing to act on the external things, and interact with the user on the basis of the recognition and the processing by known techniques. Examples of the known techniques include image processing techniques such as various types of filtering, independent component analysis, a support vector machine (SVM), and outline extraction, pattern recognition such as speech recognition and face recognition, natural language processing, knowledge information processing, reinforcement learning, a Bayesian network, a self-organizing map (SOM), a neural-network, deep learning, and various types of mechanical learning.

The basic responses in the interaction are achieved by an input recognition unit 10, an inference response unit 20, and an output control unit 30. The input recognition unit 10 recognizes the external things and phenomena such as user's actions mainly using the sensory devices such as sensors included in the sensor manipulation device group SM. The inference response unit 20 makes an inference according to situations and determines the response contents on the basis of action histories of the user and the artifact P, and other records (in a history storage unit 25, for example). The output control unit 30 outputs information and actions mainly using the information output system and the driving system included in the sensor manipulation device group SM while utilizing feedback of the output result.

When being capable of communicating with the cloud server C, the artifact P entrusts an inference determination unit C1 included in the cloud server C with the following processing: a complicated and high inference determination, an inference determination based on collective intelligence according to interaction histories of a plurality of artifacts P using the cloud server C, a storing of other records that cannot be stored in a local storage (e.g., the history storage unit 25) in the artifact P, and the access to the records.

The artifact P identifies the user who is the main other party of the interaction (what is called a “master”) by verification of the face or the voice, login authentication with input of a test word or password, or a location where the user is present, for example.

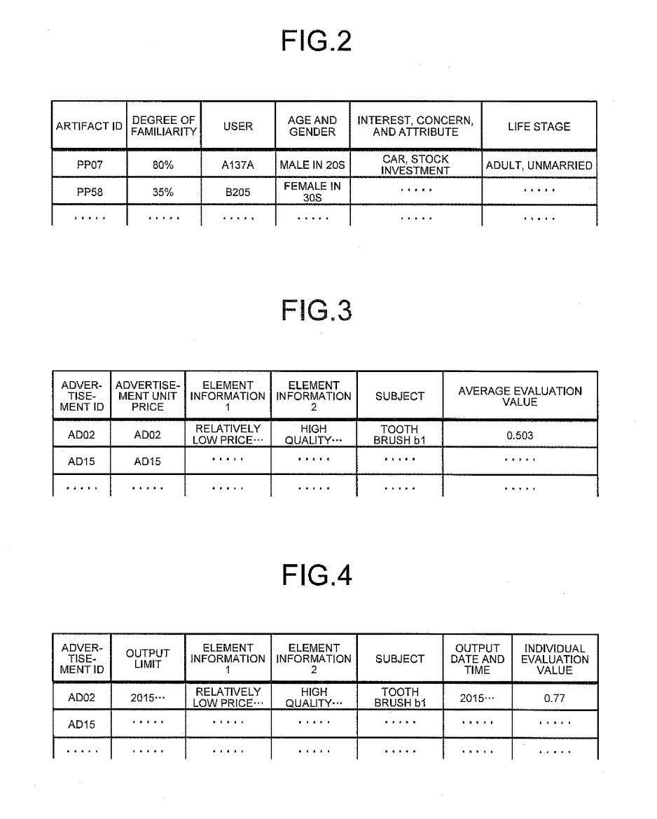

Specifically, the local determination unit 40, which is the determination unit (the relative determination unit C3 is described later), stores, in the history storage unit 25, at least one of the type and the amount of the user's action that is detected when the artifact P, which performs interactive interaction with the user, is accompanied by the user (step S1). The local determination unit 40 determines the degree of familiarity between the user and the artifact on the basis of the stored item, stores the degree of familiarity in a user information storage unit C4 included in the cloud server C (refer to FIG. 2, for example), and updates it later (step S2). The accompanying means that the user and the artifact P are present in a range in which they can interact with each other.

A change unit C5 changes the content of the interaction by the artifact P in accordance with the degree of familiarity determined by the determination unit (the local determination unit 40 and the relative determination unit C3) (step S3). Examples of the change include the change in information content that is provided by the artifact P to the user through the interaction, and whether the utterance is made to the user in a polite and formal tone or in a causal and friendly tone.

The user's action that can be used for the basis of the determination of the degree of familiarity is operation to maintain and manage the artifact P, i.e., maintenance (e.g., cleaning, charging maintenance, and checking), for example. For the cleaning, a motion of stroking the surface of the artifact P using a cleaning tool such as a cloth is detected by a camera or a contact sensor, for example. Examples of the charging maintenance include carrying the artifact to a charging station, teaching the location of the charging station or giving a route to the charging station, connecting the artifact with a charging cable, and battery exchange operation.

Examples of the checking include an inspection by lightly tapping respective portions of the sensory device by fingers, careful removing of parts so as not to be broken or disassembly operation, and activation of a self-diagnosis function built in the artifact P.

Another user's action that can be used for the basis of the determination of the degree of familiarity is a certain action that expresses the user's attachment to the artifact. Examples of the certain action may include giving a greeting or expressing a positive facial expression such as a smile to the artifact, calling the artifact by a name, attaching fittings such as cloths, eyeglasses, sunglasses, a cover, and a protection seal to the artifact, and a physical contact with the artifact such as stroking, touching, leaning, hugging, and kissing. Examples may further include carrying the artifact to a bed and taking a drive with the artifact sitting on a car seat.

Examples of the certain action that expresses the user's attachment to the artifact may also include installation of a service via the Internet or password centralized management software to the artifact P having functions of a computer, and installation of software that achieves an electronic key function to open an entrance electronic key using a short-range communication function such as near-field communication (NFC).

Another example of the user's action that can be used for the basis of the determination of the degree of familiarity is a predetermined important action such as having a meal, taking a bath, electronic business transaction, investment transaction, opening and closing of a safe, and sleeping. Whether each type of user's action is taken by the user and the amount of the action are determined by detecting, from the input of the sensor, an action pattern preliminarily defined as the user's action for each type. Some types of user's actions are detected from an information processing activity such as the Internet access performed by the user using the functions of a computer included in the artifact P.

When the user's action is the information processing activity performed using a computer other than the artifact P, the presence or absence and the amount of the user's action may be determined by accessing the computer using access authority, an ID, or a password that are preliminarily granted by the user, and monitoring or inquiring about the content of the information processing activity performed by the user.

The amount of the user's action thus determined is a range of the accompanying when the user's action is detected, for example. The accompanying is one or both of the state where the artifact P is accompanied by the user around the user and the state where the user and the artifact P are present in a range capable of performing interaction with each other. The range of the accompanying is specified by a temporal, a geographical, or a cost sharing range, a range of the action type, or a range of another factor.

The determination of the degree of familiarity may not be completed on the basis of a single artifact P. For example, the relative determination unit C3 may store the user's actions received as information about a plurality of artifacts P in an action storage unit C2 to tally the user's actions. The relative determination unit C3 is the determination unit included in the cloud server C coupled to the artifact P with the communication network N. The relative determination unit C3 may perform relative evaluation on the user's actions to obtain a certain evaluation value such as a deviation, thereby determining the degree of familiarity with the corresponding user for each of the artifacts P.

The determined degree of familiarity is stored in the user information storage unit C4 and updated (refer to FIG. 2). The user's action on the artifact P may be received from the artifact P or may be received from the control device that is used for controlling the artifact P and structured separately from the artifact P.

As for the accompanying, which is the basis for the determination of the degree of familiarity, the artifact P may be actually or virtually accompanied by the user. A user is assumed to be on an outing outside an activity base of the user or the artifact P. In this case, the determination unit also uses, as the basis for the determination of the degree of familiarity, the following virtual accompanying. In the virtual accompanying, a software agent achieved by the information processing device (e.g., a smartphone) virtually goes out with the user while the software agent is present in the smartphone and interacts with the user.

The activity base described herein means a geographical range in which the user or the artifact locates relatively for a long time (e.g., the user's house, the user's premise, the user's working space, and a building). The activity base is determined on the basis of statistical processing on position histories, or the statistical processing result and a section of an area indicated by map information or information from a floor plan.

The degree of familiarity may be determined on the basis of a feature in handling of the information processing device used for the virtual accompanying as described above. For example, whether the smartphone including the software agent is physically handled in a careful or rough manner is measured by an accelerometer built in the smartphone. On the basis of the measurement result, it is determined that as the smartphone is handled more carefully, the degree of familiarity is higher.

The following describes another example of the feature in handling. When the user always carries the smartphone in a pocket of the pants, in an inside pocket of the clothes, or in a smartphone holder, the temperature of the smartphone is probably 30s in Celsius or in a certain range around 30 degrees in Celsius in many time periods (at a rate or frequency equal to or higher than a certain value in a certain time period) when the temperature is detected by a temperature sensor, for example. In this case, it can be determined that the degree of familiarity is high.

The determination unit may determine that the degree of familiarity is high when the interaction is detected while the user performs a certain action when the user is on an outing. The interaction is not limited to that performed with voices, but may be performed by touch operation with fingers, for example. The certain action is a social activity that usually causes the operation of the information equipment to be in a negative environment such as the case where the operation is difficult, or leads to disadvantages, obstacles, or resistances.

For example, it is determined that the degree of familiarity is high when the frequency of the interaction is high such as a case where the user walks while operating the smartphone or a case where the user performs the interaction during work, a lecture, or a part-time job.

The determination unit may determine that the degree of familiarity is high when an action relating to a subject appearing in the interaction in the activity base of the user or the artifact P is detected while the user is on an outing outside the activity base. An example of the action is a case where the interaction of “I recommend a ramen (Chinese noodle) of shop A.” is made, and in a certain period of time after the interaction (e.g., within a week or a month), the user actually visits the ramen shop A.

The interaction in this case is not limited to the output of an advertisement. The action such as the actual visit to the ramen shop is not limited to a case where the artifact P is accompanied by the user. The visit may be determined on the basis of the position history acquired from a car navigation application or a map application used by the user, or on the basis of an oral report from the user to the artifact (e.g., “Today, I ate the ramen of the shop A talked with you the other day.”).

### 3. Advertisement Selection According to Degree of Familiarity

The degree of familiarity determined as described above can be utilized for reserving (allocating or selecting) an advertisement. In the advertisement server A, information about the advertisement sent from an advertiser is preliminarily stored in an advertisement storage unit A1 together with an evaluation value of the advertisement (refer to FIG. 3). A selection unit A2 (equivalent to the change unit) included in the advertisement server A selects the advertisement from the advertisement storage unit A1 in such a manner that as the degree of familiarity with the artifact P stored in a user information storage unit C4 (refer to FIG. 2) is higher, the selected advertisement has a higher evaluation value. The selection unit A2 allocates the selected advertisement as the output from the artifact P (step S4).

The criterion for advertisement selection includes not only matching in level between the degree of familiarity and the evaluation value but also whether attributes, such as an age, a gender, an interest, and a concern, fit with the conditions designated by the advertiser.

A transmission unit A4 transmits the advertisement selected by the selection unit A2 to the artifact P (step S5). For simple explanation, information about the content output from the artifact P as the advertisement (e.g., a text to be uttered as the advertisement or a product name of a subject in the advertisement) is assumed to be transmitted by the transmission unit A4 to the artifact P as advertisement data having an output time limit (refer to FIG. 4).

The transmission unit A4 may transmit only identification information, such as the ID for identifying the advertisement or a uniform resource locator (URL) for downloading, to the artifact P, and the artifact P may download the advertisement from another advertisement distribution server (not illustrated) using the identification information.

The evaluation value of the advertisement used for advertisement selection may be an achievement ratio (e.g., tentatively described as a “response ratio”, refer to FIGS. 3 and 7) of the predetermined result (e.g., purchase application or document request by the user) or an advertisement unit price, which is a bidding amount associated with the bid advertisement, for example, when the advertisement is output from the artifact P. The evaluation value may be a value obtained by multiplying the advertisement unit price associated with the advertisement by the response ratio.

The artifact P stores the advertisement transmitted from the transmission unit A4 in an advertisement storage unit 45 together with the output time limit (step S5). Thereafter, if a timing determination unit 70, which is the determination unit, determines that it is certain output timing suitable for outputting the advertisement on the basis of the acquisition of information about the user and the interaction with the user (Yes at step S7), an advertisement output unit 50 outputs the advertisement stored in the advertisement storage unit 45 (step S8).

The information about the user used for the determination of the timing is not limited to the information in the interaction but the overall information about the user obtained from the sensor group included in the artifact P. Examples of the information about the user include the location, the posture (e.g., standing or sitting on a sofa), the behavior (e.g., in eating or on the phone), and the utterance content of the user in the user's house.

Examples of the certain output timing suitable for outputting the advertisement include when the user talks to the artifact P and when the user takes a rest. When the user takes a drink, and thereafter has a seat and talks with nobody, the user probably takes a rest, for example.

For the advertisement selection, the user's life stage may be used that can be known from the continuous relation with the artifact P. In this case, a stage determination unit C6 included in the cloud server C determines the user's life stage from information obtained from the continuous interaction by the artifact P. Examples of the life stage include the age, gender, and occupation of the user, the presence or absence of a spouse or children, the number of children, the age in months or years of the child, the gender of the child, the type of school the child attends, the type of the user's house, the presence or absence or the amount of mortgage payments or savings.

The selection unit A3 prioritizes the advertisement the life stage associated with which is adapted for the user's life stage determined by the stage determination unit C6 as the advertisement to be selected for the artifact P, and allocates the advertisement to the artifact P. For example, when the life stage associated with the advertisement is that the user has a child before elementary school completion, the artifact P that receives the user's utterance “my son will be in the fourth grade of elementary school this spring.” in the interaction with the user is prioritized in the advertisement selection.

How the conditions such as the evaluation value, the degree of familiarity, the attribute, and the life stage are prioritized using what kind of logical arithmetic relation and weight can be changed in accordance with the purpose of the advertisement and other conditions. The life stage is not limited to that determined from the interaction with the artifact P. For example, the life stage explicitly registered by user registration may be used together.

### 4. Advertisement Output in Form According to Degree of Familiarity

The output forms of the advertisement from the artifact P to the user can be switched in accordance with the degree of familiarity. The target to be switched is not limited to the advertisement selected in accordance with the degree of familiarity. For example, the target may be the advertisement that is output indiscriminately or in accordance with only the user's attribute or the user's life stage other than the degree of familiarity. In this case, the advertisement output unit 50 included in the artifact P outputs the advertisement to the user in an output form according to the degree of familiarity stored in the user information storage unit C4 included in the advertisement server A.

For example, when the degree of familiarity is equal to or larger than a certain degree and the artifact P recognizes that the user is present in a certain range, the advertisement output unit 50 causes the artifact P to utter words relating to (the presence, content, or subject of) the advertisement as the output of the advertisement.

The words relating to the advertisement may be the content of the advertisement (e.g., “The fuel consumption of a new car of company A is Z kilometers.”), for example. The brand name or the company name that are the subject of the advertisement may be simply muttered. The presence of the advertisement to be output may be uttered intentionally and pompously so as to attract the user's attention to the advertisement (e.g., “I will talk about a new car, but, now, I won't talk . . . ”).

For another example, when the degree of familiarity is equal to or larger than a certain degree and the artifact P recognizes the presence of the user in a certain range and the thing relating to the advertisement, the advertisement output unit 50 may cause the artifact P to output the advertisement. The advertisement output unit 50 may cause the artifact P to output the advertisement by appropriately presenting the presence of the thing recognized by the artifact P and the relation between the thing and the advertisement.

For example, the artifact P utters “You bought a car magazine, didn't you? Speaking of cars, do you know a new car of the company A?” when the user who comes home and takes out a car information magazine from a bag.

For another example, when the degree of familiarity is equal to or larger than a certain degree, the advertisement output unit 50 may cause the artifact P to utter the content of the advertisement relating to the display content of a web site the user browses or on a screen of a television as appropriate presentation of the fact to the user like in daily conversation.

For example, when the advertisement relating to the launching of a new car of the company A is output to the user to whom the user attribute indicating that the user is interested in cars is attached, the artifact P outputs the advertisement in a form of the utterance of “By the way, I heard a new car is going to be launched by the company A.” or the artifact P displays the product image on the display screen thereof together with the utterance when the user is browsing a web site relating to cars.

The output form according to the degree of familiarity is achieved in the following manner, for example. For example, information about the advertisement including a plurality of pieces of element information each corresponding to one of a plurality of output forms is stored in the advertisement storage unit 45, which is the storage unit (refer to FIG. 3). The advertisement output unit 50 uses the element information corresponding to the output form according to the degree of familiarity out of the pieces of element information stored in the advertisement storage unit 45 (step S6), and outputs the advertisement including the element information from the artifact P to the user (step S8).

For example, when the advertisement of “tooth brush b1” of the company B is output to the user who bought a tooth brush a month ago, the advertisement is assumed to include the following two pieces of element information. One piece of information emphasizes a low price as the appealing feature of the advertising subject (e.g., the price is lower than that of the conventional one by 10%). The other piece of information emphasizes high quality as the appealing feature of the advertising subject (e.g., the result of the user review says that the quality is excellent).

In this case, when the degree of familiarity is equal to or larger than a certain degree, the advertisement output unit 50 causes the artifact P to output the advertisement to the user, i.e., to recommend the product to the user, in the form that emphasizes the high quality rather than the low price (in the example, the result of the user review says that the quality is excellent). When the degree of familiarity is smaller than the certain degree, the advertisement output unit 50 causes the artifact P to output the advertisement to the user, i.e., to recommend the product to the user, in the form that emphasizes the low price rather than the high quality (in the example, the price is lower than that of the conventional one by 10%).

The output timing of the advertisement may be determined on the basis of an activity pattern such as a lifestyle. In this case, an extraction unit (a pattern extraction unit 60 in FIG. 1) extracts the user's activity pattern such as the user's lifestyle on the basis of the acquisition of the information about the user and the interaction with the user, and causes a pattern storage unit 65 to store therein the activity pattern. The determination unit (the timing determination unit 70 in FIG. 1) determines certain output timing suitable for outputting the advertisement on the basis of the activity pattern, which is extracted by the pattern extraction unit 60 and stored in the pattern storage unit 65 (step S7).

If the timing determination unit 70 determines that it is the output timing (Yes at step S7), the advertisement output unit 50 outputs the advertisement in the output form according to the degree of familiarity from the artifact P to the user (step S8). For example, when the user takes a bath in almost the same time period every day, the artifact P may output the advertisement of a canned beer when the user ends the bathing, i.e., after the bathing, in a manner of recommendation or begging.

### 5. Evaluation of Advertising Effect Based on Interaction

The advertising effect of the advertisement output from the artifact P can be evaluated on the basis of the interaction after the output. For example, the advertisement output from the artifact P to the user and the subject of the advertisement are stored in the advertisement storage unit 45 in association with each other (step S9). An example of the manner to store the output advertisement is that a value is set to a field for an output date and time, which is a blank before the output, in the advertisement storage unit 45.

An evaluation unit A4 evaluates the advertising effect of the advertisement on the basis of the appearance of the advertisement (a coined word included in the feature of the advertisement and a catch phrase) or the subject (e.g., the brand name or the product name), which are stored in the advertisement storage unit 45, in the interaction with the user (step S10).

The evaluation can be performed by two steps. At the first step, a local evaluation unit 80 included in each artifact P obtains an evaluation value (individual evaluation value) on the basis of the interaction with the corresponding user, and causes the advertisement storage unit 45 to store therein the evaluation value (refer to FIG. 4). At the second step, the evaluation unit A4 included in the advertisement server A collects the respective individual evaluation values from the artifacts P and tallies them to obtain an average evaluation value, causes the advertisement storage unit A1 to store therein the average evaluation value, and thereafter updates the average evaluation value (refer to FIG. 3).

Examples of the case where the advertisement and the subject appear in the interaction may include many different cases. For example, the local evaluation unit 80 evaluates the advertising effect on the basis of the fact that the user requests the artifact P to output the advertisement again in the interaction (e.g., “Repeat it one more time.” or “What is X you said to me yesterday?”).

The local evaluation unit 80 adds an addition value for a positive evaluation to the value of the advertising effect (e.g., the individual evaluation value in FIG. 4) with a certain weight on the basis of the fact that the request is made to output the advertisement again. Another example of the basis for the evaluation is that the user positively replies to the interaction after the output of the advertisement, i.e., the continuation of the conversation. For example, the artifact P utters “Do you know a new car of the company A?” about the advertisement, and the user then replies to the conversation, saying “I hear the new car is popular now. My colleague bought the car.”

Another example of the basis for the evaluation is that the user requests the artifact P to perform certain information processing for the advertisement or the subject of the advertisement (hereinafter, described as “advertisement and the like”) in the interaction after the output of the advertisement. The certain information processing may be posting on a social networking service (SNS) or web searching, for example. For example, the artifact P utters “Do you know a new car of the company A?” as an introduction of the new car to be advertised, and the user then utters “What is the price range of the new car?” or “Can you display the image searching results of the new car on your screen?” to the artifact P.

Other examples of the basis for the evaluation are as follows: (a) the user talks about the advertisement and the like again after a certain time period elapses from the output of the advertisement; (b) the user talks about the advertisement and the like a certain number of times or more after the output of the advertisement; (c) the user talks about the advertisement and the like in a certain frequency or more after the output of the advertisement; and (d) the user talks about the advertisement and the like with another user or another artifact after the output of the advertisement.

Still another example of the basis for the evaluation is that users other than the target user to whom the advertisement is output are also influenced by the advertisement. The evaluation unit A4 evaluates the advertising effect on the basis of the fact that other users take a certain action relating to the advertisement and the like after the output of the advertisement. The other users are users other than the user to whom the advertisement is output (herein after, described as the “target user”) among users identified by the artifact P, and have certain relations with the target user.

Examples of the users who have certain relations with the target user may include a user who appears together with the target user in the visual field of the artifact P in a certain frequency or more, a user who calls the name of the target user or whose name is called by the target user in a one-way manner, or who calls the name of the target user and whose name is called by the target user, and a user who physically touches the target user. Those relations between the users and the target user can be extracted from the sensor information and the interaction histories. The users may be the family living together with the target user. In this case, information about the family such as their face patterns and voiceprints is preliminarily and declaredly registered in the artifact P or the cloud server C.

Examples of the certain action relating to the advertisement and the like include the request to output the advertisement again, the request to perform certain information processing, and the talk about the advertisement and the like, which are described above. In addition, the examples include a purchase application, a document request, and acquisition of a product serving as the subject of the advertisement and presentation of the product in the visual field of the camera included in the artifact P.

Using a single basis or a combination of the bases, the individual evaluation value is obtained for each advertisement when the artifact P outputs the advertisement to the user (refer to FIG. 4). The average evaluation value, which is obtained by tallying the individual evaluation values (refer to FIG. 3), is used for advertisement selection.

### 6. Advantages

As described above, the information processing apparatus in the embodiment includes the determination unit (the local determination unit 40 included in the artifact P and the relative determination unit C3 included in the cloud server C) that determines a degree of familiarity between the user and the artifact P, which performs interactive interaction with the user, on the basis of at least one of the type and the amount of the user's action detected when the artifact P is accompanied by the user, and the change unit C5 that changes the content of the interaction in accordance with the degree of familiarity determined by the determination unit.

In the embodiment, the user's action is maintenance of the artifact P.

In the embodiment, the user's action is a certain action that expresses the user's attachment to the artifact P.

In the embodiment, the user's action is a predetermined important action.

In the embodiment, the amount of the user's action is a range of the accompanying when the user's action is detected.

In the information processing apparatus in the embodiment, the determination unit determines the degree of familiarity by the relative evaluation of the user's actions received from a plurality of artifacts P by the server system coupled to the artifacts P with the communication network N.

In the information processing apparatus in the embodiment, the virtual accompanying in which the artifact P achieved by a software agent in the information processing device interacts with the user who is on an outing outside an activity base of the user or the artifact P is also the basis for the determination unit determining the degree of familiarity.

In the information processing apparatus in the embodiment, the degree of familiarity is determined on the basis of a feature in handling the information processing device used for the virtual accompanying.

In the information processing apparatus in the embodiment, the determination unit determines that the degree of familiarity is high when the interaction is detected while the user performs a certain action when the user is on the outing.

In the information processing apparatus in the embodiment, the determination unit determines that the degree of familiarity is high when an action relating to a subject appearing in the interactive interaction in the activity base of the user or the artifact P is detected while the user is on the outing outside the activity base.

In the information processing method in the embodiment, a computer executes the determination processing that determines a degree of familiarity between the user and the artifact P, which performs interactive interaction with the user, on the basis of at least one of the type and the amount of the user's action detected when the artifact P is accompanied by the user, and the changing processing that changes a content of the interaction in accordance with the degree of familiarity determined by the determination processing.

The information processing apparatus in the embodiment includes the selection unit A2 that selects the advertisement for the artifact P, which performs interactive interaction with the user, in such a manner that as the degree of familiarity of the artifact P with the user who is the other party of the interaction is higher, the selected advertisement has a higher evaluation value, and the transmission unit A4 that transmits the advertisement selected by the selection unit A2 to the artifact P.

In the embodiment, the evaluation value is an advertisement unit price associated with the advertisement.

In the information processing apparatus in the embodiment, the evaluation value is a value obtained by multiplying the advertisement unit price associated with the advertisement by an achievement ratio of the predetermined result when the advertisement is output.

In the information processing apparatus in the embodiment, the artifact P includes the advertisement storage unit 45 (an example of the storage unit) that stores therein the advertisement transmitted by the transmission unit A4, the timing determination unit 70 (an example of the determination unit) that determines certain output timing suitable for outputting the advertisement on the basis of the acquisition of information about the user and the interaction with the user, and the advertisement output unit 50 (an example of the output unit) that outputs the advertisement stored in the advertisement storage unit 45 when the timing determination unit 70 determines that it is the certain output timing.

The information processing apparatus in the embodiment further includes the stage determination unit C6 (an example of the life stage determination unit) that determines the user's life stage from information obtained from the continuous interaction by the artifact P. The selection unit A2 prioritizes the advertisement the life stage associated with which is adapted for the user's life stage determined by the stage determination unit C6 as the advertisement to be selected for the artifact P, and allocates the advertisement to the artifact P.

In the information processing method in the embodiment, a computer executes the selection processing that selects the advertisement for the artifact P, which performs interactive interaction with the user, in such a manner that as the degree of familiarity of the artifact P with the user who is the other party of the interaction is higher, the selected advertisement has a higher evaluation value, and the transmission processing that transmits the advertisement selected by the selection unit to the artifact P.

The information processing apparatus in the embodiment includes the advertisement output unit 50 (an example of the output unit) that outputs the advertisement from the artifact P to the user in an output form according to the degree of familiarity between the artifact P, which performs interactive interaction with the user, and the user who is the other party of the interaction.

In the information processing apparatus in the embodiment, when the degree of familiarity is equal to or larger than a predetermined reference and the artifact P recognizes that the user is present in a certain range, the advertisement output unit 50 causes the artifact P to utter words relating to the advertisement as the output of the advertisement.

In the information processing apparatus in the embodiment, when the degree of familiarity is equal to or larger than a predetermined reference and the artifact P recognizes the presence of the user in a certain range and the thing relating to the advertisement, the advertisement output unit 50 causes the artifact P to output the advertisement.

In the information processing apparatus in the embodiment, the advertisement output unit 50 causes the artifact P to output the advertisement by appropriately presenting the presence of the thing recognized by the artifact P and the relation between the thing and the advertisement.

In the information processing apparatus in the embodiment, when the degree of familiarity is equal to or larger than a predetermined reference, the advertisement output unit 50 causes the artifact P to utter the content of the advertisement relating to the display content on a screen the user browses as appropriate presentation of the fact to the user.

The information processing apparatus in the embodiment includes the advertisement storage unit 45 that stores therein information about the advertisement including a plurality of pieces of element information each corresponding to one of a plurality of output forms. The advertisement output unit 50 uses the element information corresponding to the output form according to the degree of familiarity out of the pieces of element information included in the information about the advertisement, the information being stored in the advertisement storage unit 45, and outputs the advertisement including the element information from the artifact P to the user.

In the information processing apparatus in the embodiment, the element information includes a low price and high quality as the appealing features of the advertising subject, and the advertisement output unit 50 causes the artifact P to output the advertisement to the user in the output form that emphasizes the high quality rather than the low price when the degree of familiarity is equal to or larger than a predetermined reference.

The information processing apparatus in the embodiment further includes the pattern extraction unit 60 (an example of the extraction unit) that extracts the user's activity pattern on the basis of the acquisition of the information about the user and the interaction with the user, and the timing determination unit 70 (an example of the determination unit) that determines certain output timing suitable for outputting the advertisement on the basis of the activity pattern extracted by the pattern extraction unit 60. The advertisement output unit 50 outputs the advertisement in the output form according to the degree of familiarity from the artifact P to the user when the timing determination unit 70 determines that it is the output timing.

In the information processing method in the embodiment, a computer executes the output processing that outputs the advertisement from the artifact P to the user in the output form according to the degree of familiarity between the artifact P, which performs interactive interaction with the user, and the user who is the other party of the interaction.

The information processing apparatus in the embodiment includes the advertisement storage unit 45 (an example of the subject storage unit) that stores therein the advertisement output from the artifact P, which performs interactive interaction with the user, to the user and the subject of the advertisement in association with each other, and the evaluation unit A4 that evaluates the advertising effect of the advertisement on the basis of the appearance of the advertisement or the subject stored in the advertisement storage unit 45, in the interaction with the user.

In the information processing apparatus in the embodiment, the evaluation unit A4 evaluates the advertising effect on the basis of the fact that the user requests the artifact P to output the advertisement again in the interaction.

In the information processing apparatus in the embodiment, the evaluation unit A4 evaluates the advertising effect on the basis of the fact that the user positively replies to the interaction after the output of the advertisement.

In the information processing apparatus in the embodiment, the evaluation unit A4 evaluates the advertising effect on the basis of the fact that the user requests the artifact P to perform predetermined information processing for the advertisement or the subject of the advertisement in the interaction after the output of the advertisement.

In the information processing apparatus in the embodiment, the evaluation unit A4 evaluates the advertising effect on the basis of the fact that the user talks about the advertisement or the subject again after a predetermined time period elapses from the output of the advertisement.

In the information processing apparatus in the embodiment, the evaluation unit A4 evaluates the advertising effect on the basis of the fact that the user talks about the advertisement or the subject a predetermined number of times or more after the output of the advertisement.

In the information processing apparatus in the embodiment, the evaluation unit A4 evaluates the advertising effect on the basis of the fact that the user talks about the advertisement or the subject in a predetermined frequency or more after the output of the advertisement.

In the information processing apparatus in the embodiment, the evaluation unit A4 evaluates the advertising effect on the basis of the fact that the user talks about the advertisement or the subject with another user or another artifact P after the output of the advertisement.

In the information processing apparatus in the embodiment, the evaluation unit A4 evaluates the advertising effect on the basis of the fact that other users take a certain action relating to the advertisement or the subject after the output of the advertisement. The other users are users other than the target user to whom the advertisement is output among users identified by the artifact P, and have predetermined relations with the target user.

In the information processing in the embodiment, a computer executes the processing that stores the advertisement output from the artifact P, which performs interactive interaction with the user, to the user and the subject of the advertisement in association with each other, and the processing that evaluates the advertising effect of the advertisement on the basis of the appearance of the stored advertisement or the subject in the interaction with the user.

(1-1) The embodiment determines the degree of familiarity between the artifact and the user who continuously interacts with the artifact, and controls the behavior of the artifact such that the artifact changes information to be output in accordance with the degree of familiarity, for example, thereby making it possible to achieve the interaction adapted for the relation between the artifact and the user.

(1-2) As the degree of familiarity is higher, the frequency of maintenance that requires burdens such as time and labor increases. The embodiment uses the maintenance as the basis for the determination of the degree of familiarity, thereby making it possible to determine the degree of familiarity more appropriately.

(1-3) The user's attachment to a target is stronger, the degree of familiarity with the target increases. The embodiment uses the action that expresses the user's attachment as the basis for the determination of the degree of familiarity, thereby making it possible to determine the degree of familiarity more appropriately.

(1-4) A person tends to consider the other party accompanied by the person in an action involving the person's vital interests as the other party with which the person has a high degree of familiarity. The embodiment uses an important certain action as the basis for the determination of the degree of familiarity, thereby making it possible to more appropriately determine the degree of familiarity between the user and the artifact.

(1-5) As a person has a higher degree of familiarity with the other party, the person causes the other party to be accompanied by the person for a longer time and in a longer distance with expenses. The embodiment uses the range of the accompanying as the basis for the determination of the degree of familiarity, thereby making it possible to determine the degree of familiarity more appropriately.

(1-6) The embodiment determines the degree of familiarity on the basis of relative evaluation based on a plurality of artifacts and users by a server, what is called a could server, serving as a back-end system using an artificial intelligence (AI) rather than a case where the degree of familiarity is determined for each artifact or user using a single and absolute basis. As a result, even if an environment such as a social tendency or a trend in relation to how the user comes in contact with the artifact is changed, a constant rate of or the constant number of ways can be extracted as ones having a high degree of familiarity.

Consequently, the interaction contents are caused to clearly differ among users even under any circumstance. For example, when a certain advertisement is output, a desired amount of an advertisement stock, i.e., an output opportunity of advertisement can be secured as the interaction contents caused to differ among users. For another example, when a privilege is granted to or another promotion scheme is applied to the user with whom the familiarity is high, a desired amount of a promotion effect can be secured as the interaction contents caused to differ among users.

(1-7) When the artifact virtually goes out and interacts with the user as a software agent in a smartphone, the embodiment use the fact as the basis for the determination of the degree of familiarity, thereby making it possible to appropriately determine the degree of familiarity in accordance with the various artifacts and interaction forms.

(1-8) The embodiment uses, as the basis for the determination of the degree of familiarity, handing of the information processing device that virtually includes the artifact as the software agent, thereby making it possible to more multilaterally determine the degree of familiarity.

(1-9) The embodiment determines that the degree of familiarity is high when the interaction is performed even under a circumstance where a large obstacle and resistance are usually present for performing interaction such as a case where the user performs activities while being on an outing. As a result, opportunities are increased where the degree of familiarity is determined to be particularly high, thereby making it easy to clarify the difference in the degree of familiarity between the artifact and the user.

(1-10) A person tends to be influenced by the interaction with the other party with which the degree of familiarity is high. The embodiment uses, as the basis for the determination of the degree of familiarity, the fact that the interaction with the artifact in the base influences the user's action while the user is on an outing, thereby making it possible to appropriately determine the degree of familiarity.

(2-1) The embodiment allocates the advertisement having a high evaluation value to the user with whom the degree of familiarity is high, i.e., the user, thereby making it possible to effectively use the advertisement output opportunity. The advertiser sets an expensive advertisement unit price to a biding amount of the advertisement to be prioritized as the evaluation value so as to allocate a huge advertising budget to the advertisement output expected to exert great influence, thereby making it possible to implement a clearer advertising strategy.

(2-2) The embodiment allocates the advertisement in such a manner that as the bid advertisement unit price is higher, more advertisement is allocated to the artifact that has a high degree of familiarity with the user with whom the interaction is performed. As a result, the advertisement having a high advertisement unit price, i.e., a high value, is allocated to the advertisement output opportunity expected to have a larger advertising effect of influencing the user, thereby making it possible to appropriately use the advertisement output opportunity having a high value.

(2-3) The embodiment uses, as the evaluation value, a value obtained by multiplying the advertisement unit price, which provides an income of the advertisement provider from the advertiser when the advertisement is output or a certain result is achieved by the output, by an achievement ratio of the certain result by the advertisement. As a result, the most effective advertisement allocation can be achieved on the basis of both of the size and the ratio of the value achieved by the advertisement.

(2-4) The embodiment stores the selected advertisement and determines favorable timing to output the advertisement, thereby making it possible to expect the advertising effect.

(2-5) The embodiment provides the advertisement (including a recommendation) fitting with the user's life stage known from the continuous interaction with the user, thereby making it possible to achieve an excellent advertising effect.

(3-1) The embodiment switches the forms of the advertisement output from the artifact that performs interactive interaction with the user in accordance with the degree of familiarity with the user, thereby making it possible to expect the maximum advertising effect regardless of the degree of familiarity.

(3-2) A monologue of the other party with which the degree of familiarity is high attracts the user's attention. The embodiment thus causes the artifact having a high degree of familiarity with the user to talk to itself about the advertisement, thereby making it possible to attract the user's attention to the content and the subject of the advertisement or the presence of the advertisement. As a result, an excellent advertising effect such as strong memorization and a high conversion rate can be achieved.

(3-3) The embodiment outputs the advertisement from the artifact when the user with whom the familiarity is high is near the artifact and a thing relating to the advertisement is present, thereby making it possible to effectively attract the user's attention to the advertisement.

(3-4) The user does not always recognize the thing recognized by the artifact and the relation between the thing and the advertisement. The embodiment thus outputs the advertisement with the appropriate presentation of them, thereby assisting the user's understanding of why such a topic is talked now. As a result, the user can accept the advertisement content without feeling a sense of abruptness.

(3-5) The embodiment talks to the user about the advertisement content relating to the content displayed on the screen the user watches in such a manner that the fact is appropriately presented for introducing a new topic or developing the topic in daily conversation with a close friend. As a result, the artifact can cause the user who is browsing the content to pay attention to the advertisement content without feeling uncomfortable, thereby making it possible to induce the user to perform the next action such as to memorize the subject of the advertisement, request documents about the subject of the advertisement, or apply for purchasing the subject of the advertisement.

(3-6) In the embodiment, the element information for each output form according to the degree of familiarity is preliminarily included in the information about the advertisement. The element information according to the output form actually used is employed, thereby eliminating a burden of the artifact to adapt the advertisement in accordance with the output form.

(3-7) The user tends to purchase a product even if the product is slightly expensive when a close friend appeals to the user by using the quality. The embodiment thus outputs the advertisement from the artifact having a high degree of familiarity with the user in the output form that emphasizes the high quality, thereby achieving an excellent advertising effect such as a high conversion rate.

(3-8) The embodiment extracts the user's activity pattern while the artifact is accompanied by the user in the user's daily life, determines timing for effective presentation of the advertisement (recommendation), and outputs the advertisement, thereby making it possible to expect an excellent advertising effect.

(4-1) The embodiment evaluates the subject of the advertisement output to the user from the artifact that performs the interactive interaction with the user on the basis of the fact that the subject appears in the interactive interaction between the user and the artifact after the output, thereby making it possible to appropriately evaluate the advertising effect such as the memorization in accordance with the characteristic of the interactive interaction, which is the continuous communication. The appropriate evaluation of the advertising effect allows the determination of the advertising value and the advertisement allocation to be appropriately performed.

(4-2) The embodiment understands that the user's attention is attracted to the advertisement or the subject when the user requests re-output of the advertisement after the output of the advertisement, thereby making it possible to appropriately evaluate the advertising effect on the basis of the request.

(4-3) The embodiment understands that the user's attention is attracted to the advertisement or the subject when the user positively replies to the interaction after the output of the advertisement, thereby making it possible to appropriately evaluate the advertising effect on the basis of the reply.

(4-4) The embodiment understands that the user's attention is attracted to the advertisement or the subject when the user requests certain information about the advertisement and the subject from the artifact after the output of the advertisement, thereby making it possible to appropriately evaluate the advertising effect on the basis of the request.

(4-5) The embodiment understands that the user's attention is attracted to the advertisement or the subject and the user memorizes it when the user talks about the advertisement or the subject again after a time elapses from the output of the advertisement, thereby making it possible to appropriately evaluate the advertising effect on the basis of the request.

(4-6) The embodiment understands that the user's attention is attracted to the advertisement or the subject and the user memorizes it when the user talks about the advertisement or the subject many times after the output of the advertisement, thereby making it possible to appropriately evaluate the advertising effect on the basis of the request.

(4-7) The embodiment understands that the user's attention is attracted to the advertisement or the subject and the user memorizes it when the user frequently talks about the advertisement or the subject after the output of the advertisement, thereby making it possible to appropriately evaluate the advertising effect on the basis of the request.

(4-8) When the user talks about the advertisement or the subject with another person and another artifact after the output of the advertisement, the embodiment understands that the user's attention is attracted to the advertisement or the subject and the user memorizes it to the degree that the user transmits information to and collects information from the other person, thereby making it possible to appropriately evaluate the advertising effect on the basis of the fact that user talks in such a manner.

(4-9) When another user who has a relation with the user to whom the advertisement is output performs a certain action on the advertisement or the subject after the output of the advertisement, the embodiment understands that the user's interest, attention and other influences are spread to the other user, thereby making it possible to appropriately evaluate the advertising effect on the basis of the fact. In particular, as the purchasing amount of products or services is larger, wishes of the family and other friends have more influence on the purchasing. It is thus significantly meaningful to use the spreading of the influence to the other user as the evaluation basis.

### 7. Other Embodiments

The embodiment and the drawings are represented by way of example only. The presence or absence or arrangement of the respective components, and the order and the contents of the processes can be appropriately changed. The embodiment includes the following exemplary modifications and other embodiments. It can be determined without any limitation that the respective components illustrated in FIG. 1 (refer to FIG. 1) are functionally arranged in any of the advertisement server A, the cloud server C, and the artifact P in accordance with the implementation.

The advertisement server A and the cloud server C may be integrated. It is not indispensable for the embodiment that the information processing apparatus is structured as the system that includes the servers coupled with each other with the communication network N as described in the embodiment. The information processing apparatus that has all of the functions including the determination of the degree of familiarity and advertisement selection may be achieved by a single artifact P, or by being arranged in a plurality of artifacts P that operate in cooperation with one another. One or both of the function groups of the cloud server C and the advertisement server A may be included in the artifact P.

The storage unit is not limited to the local storage in the apparatus. The storage unit may be a remote storage such as a network computing or a cloud computing. The storage unit may include not only the storing space of data but also functions such as to input, output, and manage data. The structure of the storage unit in the embodiment is described for expository convenience. The storage unit may be appropriately divided or integrated with another storage unit. Any storage units used for storing therein the processing targets, the working areas, and the results may be appropriately used besides the illustrated storage units.

The arrows in the drawings (e.g., in FIG. 1) are auxiliary indications of the major directions of flows of data and control, and do not exclude other flows and not limit the directions of the flows. The units other than the storage units are the processing units that achieve and perform the functions and operations for the information processing described in the embodiment (e.g., in FIG. 1). Those functional units are classified for expository convenience and are not required to be the same as actual hardware components and software modules.

The aspects in the embodiment can be applied to other categories (e.g., methods, programs, and systems including terminals) that are not described herein. When they are applied to the categories of the methods and the programs, the “unit” in the apparatus is appropriately read as a “process” or a “step”. The “functional units” (sections or modules) described as the components of the embodiment and the embodiments are not limited to hardware components and software components. A part or the whole of the units thus can be read as “functional means”.

The order of the processes and steps described in the embodiments can be changed. The processes and steps described in the embodiments can be performed in such a manner that some of them are performed together or they are grouped and performed group by group. The CPU, the cores, the threads, and the like that achieve and perform the respective units, processes, and steps may be common to one another, or may differ for each unit, process, step, and timing.

The functions provided by an external server may be called using an application program interface (API) or a network computing, what is called a cloud computing, to achieve the respective units in the embodiments. The respective units in the embodiments are not limited to being achieved by the arithmetic controller of the computer. The respective units may be achieved by another information processing mechanism such as an electronic circuit, which is hardware.

The embodiment has an advantage of achieving smooth interaction adapted for the degree of familiarity with the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An artifact that interacts with a user, comprising:
a determination unit that determines a degree of familiarity between the artifact and the user;
an output unit that outputs an advertisement from the artifact to the user in an output form according to the degree of familiarity.

2. The artifact according to claim 1, wherein the output unit causes the artifact to utter words relating to the advertisement as the output of the advertisement when the degree of familiarity is equal to or larger than a predetermined reference and the artifact recognizes that the user is present in a certain range.

3. The artifact according to claim 1, wherein the output unit causes the artifact to output the advertisement when the degree of familiarity is equal to or larger than a predetermined reference, the artifact recognizes a presence of the user in a certain range, and a thing relating to the advertisement.

4. The artifact according to claim 3, wherein the output unit causes the artifact to output the advertisement by appropriately presenting the presence of the thing recognized by the artifact and a relation between the thing and the advertisement.

5. The artifact according to claim 1, wherein the output unit causes the artifact to utter content of the advertisement relating to display content on a screen the user browses as appropriate presentation of a fact to the user when the degree of familiarity is equal to or larger than a predetermined reference.

6. The artifact according to claim 1, further comprising:
a storage unit that stores a plurality of pieces of element information associated with the advertisement, each piece corresponding to one of a plurality of output forms, wherein the output unit causes the artifact to output the advertisement in an output form corresponding to a piece of element information corresponding to the degree of familiarity.

7. The artifact according to claim 6, wherein the element information includes a low price and high quality as appealing features of an advertising subject, and the output unit causes the artifact to output the advertisement to the user in an output form that emphasizes high quality rather than a low price when the degree of familiarity is equal to or larger than a predetermined reference.

8. The artifact according to claim 1, further comprising:
an extraction unit that extracts a user's activity pattern based on acquisition of information about the user and interaction with the user, and
a determination unit that determines an output time suitable for outputting the advertisement based on the activity pattern extracted by the extraction unit,
wherein the output unit outputs the advertisement at the output time.

9. An information processing method to be executed by a computer, comprising:
determining a degree of familiarity between an artifact and a user that interacts with the artifact; and
outputting an advertisement from the artifact to the user in an output form according to a degree of familiarity between the artifact and the user.
